(19) United States
(12) Patent Application Publication
(10) Pub. No.: US 2026/0081374 A1
(43) Pub. Date: Mar. 19, 2026

(54) Inverted Coaxial Substrate Connector

(71) Applicant: TE Connectivity Solutions GmbH, Schaffhausen (CH)

(72) Inventors: Francis John BLASICK, Halifax, PA (US); Bruce Allen CHAMPION, Camp Hill, PA (US); Andrew MORRIS, Harrisburg, PA (US); Jonathan T. KRATZER, Lititz, PA (US)

(73) Assignee: TE Connectivity Solutions GmbH, Schaffhausen (CH)

(21) Appl. No.: 19/306,348

(22) Filed: Aug. 21, 2025

Related U.S. Application Data
(60) Provisional application No. 63/695,221, filed on Sep. 16, 2024.

(51) Int. Cl. H01R 12/70; H01R 12/71; H01R 13/50; H01R 13/516; H01R 13/6594; H01R 13/6598

(52) U.S. Cl. CPC H01R 12/7082; H01R 12/712; H01R 13/50; H01R 13/516; H01R 13/6594; H01R 13/6598

(57) ABSTRACT

An electrical assembly having a substrate and an RF connector. The substrate has an opening which extends from a first surface of the substrate to a second surface of the substrate. The RF connector includes a conductive shell, a dielectric insert and a contact. The conductive shell has a mating connector receiving portion and a substrate mounting portion. The substrate mounting portion has a substrate mounting surface which engages the first surface of the substrate. The mating connector receiving portion extends from the substrate mounting surface through the opening to the second surface of the substrate. The contact has a surface mount portion positioned proximate the substrate mounting surface of the substrate mounting portion. The surface mount portion is mechanically and electrically engaged with a contact pad on the first surface of the substrate.

### BACKGROUND OF THE INVENTION

The invention relates generally to an inverted coaxial connector which terminates to one side of a substrate or printed circuit board (PCB), but has a mating interface that is accessible on an opposite side of the substrate or PCB via an opening in the substrate.

In various electrical assemblies or systems components on a main card backplane must be electrically connected to components on a mezzanine card. As the electrical assemblies and the components become more complicated and numerous, space on the surface of the main card backplane the mezzanine card to house the components is difficult find. In order to allow for more components, the components may be terminate to both sides of the mezzanine card. While this provides more surface area for the components, the connections between the components on a main card backplane and the components on a mezzanine card is complicated due to limited space. In particular, when high signal frequencies are required, the connections must maintain the signal integrity while occupying as little space as possible.

It would, therefore, be beneficial to provide an inverted coaxial printed circuit board (PCB)connector which terminates to one side of the PCB, but has a mating interface that is accessible on an opposite side of the PCB via a through-hole in the PCB, thereby allowing for proper signal integrity while occupying minimal board space and valuable space above and below the mezzanine card.

### SUMMARY OF THE INVENTION

An embodiment is directed to an RF connector having a conductive shell, a dielectric insert and a contact. The conductive shell has a mating connector receiving portion and a substrate mounting portion. The substrate mounting portion has a substrate mounting surface, the mating connector receiving portion extends from the substrate mounting surface. The contact has a surface mount portion positioned proximate the substrate mounting surface of the substrate mounting portion.

An embodiment is directed to an electrical assembly having a substrate and an RF connector. The substrate has an opening which extends from a first surface of the substrate to a second surface of the substrate. The RF connector includes a conductive shell, a dielectric insert and a contact. The conductive shell has a mating connector receiving portion and a substrate mounting portion. The substrate mounting portion has a substrate mounting surface which engages the first surface of the substrate. The mating connector receiving portion extends from the substrate mounting surface through the opening to the second surface of the substrate. The contact has a surface mount portion positioned proximate the substrate mounting surface of the substrate mounting portion. The surface mount portion is mechanically and electrically engaged with a contact pad on the first surface of the substrate. An electrical connection can be made between a device on the second side of the substrate and a component mounted on the first side through the RF connector.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective front view of a first illustrative embodiment of right angle RF connector according to the present invention mounted on a substrate.

FIG. 2 is a perspective back view of the connector and substrate of FIG. 1.

FIG. 3 is a side view of the connector and substrate of FIG. 1.

FIG. 4 is a top view of the connector and substrate of FIG. 1.

FIG. 5 is a cross-sectional view of the connector and substrate taken along line 5-5 of FIG. 3.

FIG. 6 is a perspective view of the RF connector similar to the RF connector of FIG. 1, with a cover mounting member exploded therefrom.

FIG. 7 is a cross-sectional view of the connector taken along line 7-7 of FIG. 6.

FIG. 8 is a perspective front view a mating RF connector mated to the connector of FIG. 1.

FIG. 9 is a side view of the connector, substrate and mating connector of FIG. 8.

FIG. 10 is a cross-sectional view of the connector, substrate and mating connector taken along line 10-10 of FIG. 8.

FIG. 11 is a diagrammatic view of a system in which the right angle RF connector of the present invention is used.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

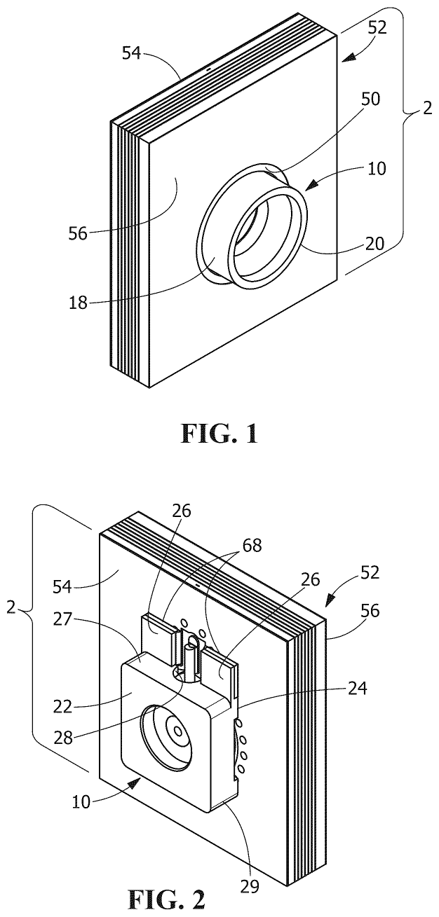

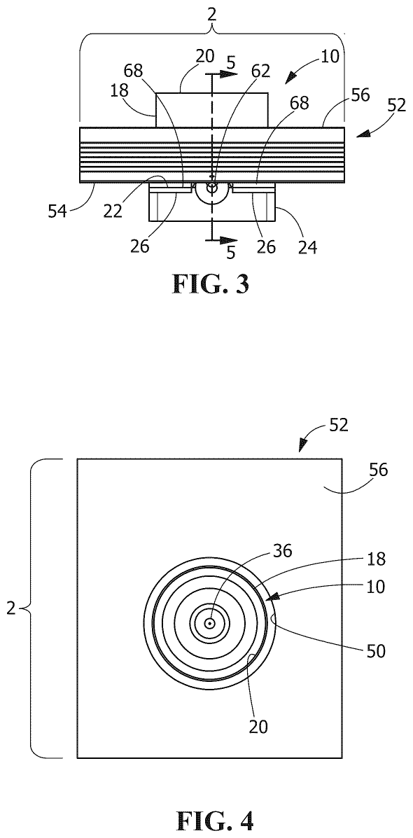

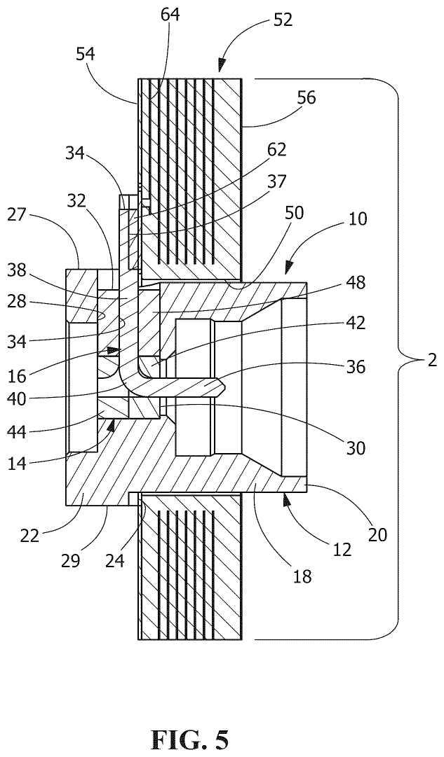

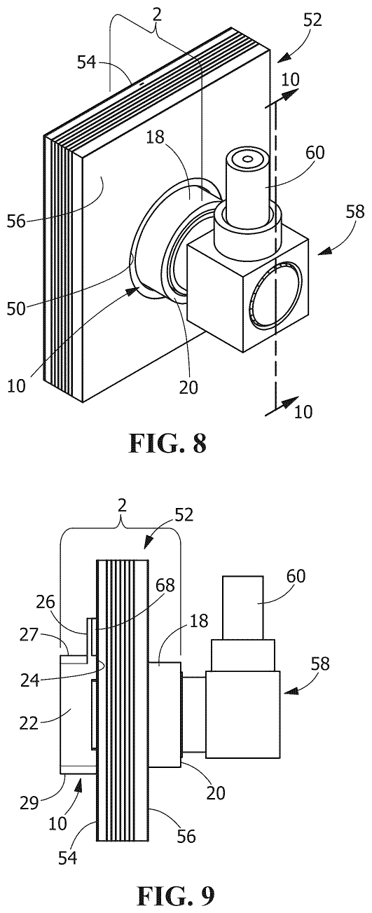

As shown in FIGS. 1 through 10, a right angle RF connector 10 is mounted in an opening 50 of a substrate or printed circuit board 52 to form an electrical assembly 2. As shown in FIGS. 5, 6, 7 and 10, the connector 10 includes a conductive or metal shell 12, a dielectric insert assembly 14, and a pin or contact 16.

In the illustrative embodiment shown, the metal shell 12 is formed in one piece and is made of metal, but other configurations and conductive material which provides the desired shielding may be used. The shell 12 has a mating connector receiving portion 18 with a mating connector receiving surface 20 and a substrate mounting portion 22 with substrate mounting surface 24. The mating connector receiving surface 20 extends in a plane which is essentially parallel to a plane in which the substrate mounting surface 24 extends. The mating connector receiving portion 18 extends from the substrate mounting surface 24 of the substrate mounting portion 22.

PCB ground or legs 26 extend from the substrate mounting portion 22 of the shell 12. In the illustrative embodiment shown, the PCB ground or legs 26 are integrally formed with the shell 12, but other configurations may be used which provide an electrical connection between the PCB ground or legs 26 and the shell 12. The PCB ground or legs 26 are positioned proximate the substrate mounting surface 24 of the substrate mounting portion 22.

A dielectric receiving passage 28 is provided in the substrate mounting portion 24. The dielectric receiving passage 28 extends from a first surface 27 of the substrate mounting portion 24 toward a second surface 29 of the substrate mounting portion 24. The dielectric receiving passage 28 opens to the mating connector receiving portion 18. The dielectric receiving passage 28 has a circular cross section with a constant radius.

The dielectric insert assembly 14 may be formed by different methods, including molding or an additive process, such as 3D printing. The dielectric insert assembly 14 is made of an insulating material that does not conduct electricity. The dielectric insert 14 is configured to be positioned in the dielectric receiving passage 28. The dielectric insert assembly 14 has a circular cross section with a constant radius which extends from a first surface 30 proximate the mating connector receiving portion 18 to a second surface 32 in the substrate mounting portion 22. The first surface 30 extends in a plane which is essentially perpendicular to a plane in which the second surface 32 extends. The radius of the dielectric insert assembly 14 is approximately equal to the radius of the dielectric receiving passage 28. The dielectric insert assembly 14 has a contact receiving passage 34 which extends through the dielectric insert assembly 14 from the first surface 30 to the second surface 32.

The contact 16 is made of conductive material and is positioned in the contact receiving passage 34. The contact 16 has a circular cross section with a constant radius. The radius of the contact 16 is approximately equal to the radius of the contact receiving passage 34. The contact 16 has a first straight portion 36 which extends into the mating connector receiving portion 18, a second straight portion 38 which extends into the substrate mounting portion 22, and a arcuate portion 40 which is positioned in the contact receiving passage 34 and which extends between the first straight portion 36 and the second straight portion 38. The second straight portion 36 has a surface mount portion 37 proximate a free end 39 thereof. The surface mount portion 37 is positioned proximate the substrate mounting surface 24 of the substrate mounting portion 22.

In the illustrative embodiment shown in FIGS. 1 through 5 and 8 through 10, the dielectric insert assembly 14 is made of three components. In other embodiments the dielectric insert assembly 14 may have a different configurations number of components.

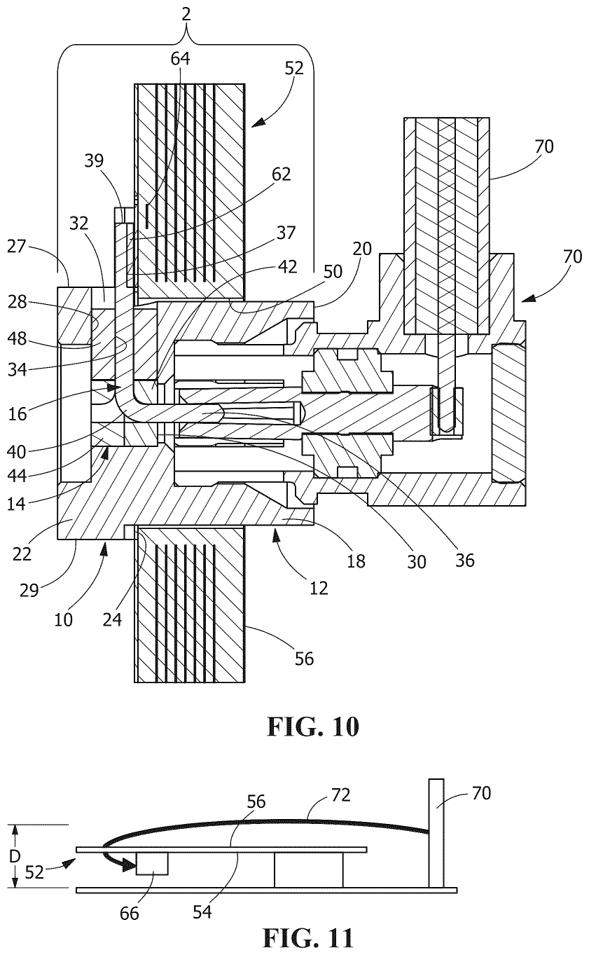

As shown in FIGS. 5 and 10 a first component 42 is a has a circular cross section and extends around the first straight portion 36 of the contact 16. The second component 44 is positioned to the side of the contact 16 and to the side of the first component, as viewed in FIGS. 5, 7 and 10. The second component 44 has a circular cross section. In the illustrative embodiment shown, the second component 44 has the same configuration as the first component 42. However, the second component 44 may have other configurations. A third component 48 is positioned proximate the first component 42 and the second component 44. The third component 48 extends 360 degrees around the second straight portion 38 of the contact 16. The dielectric strengths of the first component 42, the second component 44 and the third component 48 may be the same or may be varied to provide the desired performance.

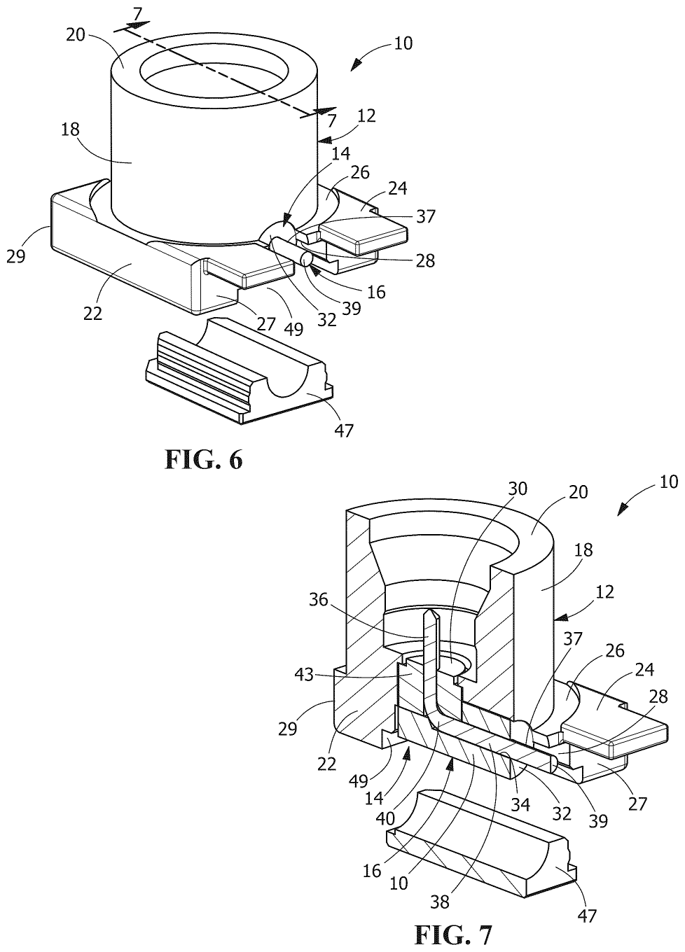

FIGS. 6 and 7 illustrate a slightly different embodiment. As shown in FIG. 7, the dielectric insert assembly 14 is made of two components. A first component 43 is a has a circular cross section and extends around the first straight portion 36 of the contact 16. A second component 45 is positioned proximate the first component 43. The second component 45 extends 360 degrees around the second straight portion 38 of the contact 16. The dielectric strengths of the first component 43 and the second component 45 may be the same or may be varied to provide the desired performance. A cover mounting member 47 is also provided in the embodiment shown in FIGS. 6 and 7. The cover mounting member 47 is configured to be positioned and maintained in the cavity 49 of the shell 12. The cover mounting member 47 cooperates with the second component 45 to properly position and maintain the second component 45 and the dielectric insert assembly 14 in the shell 12.

In use, the connector 10 is inserted into the opening 50 of the substrate 52 to form the electrical assembly 2. In this position, the mating connector receiving portion 18 extends through the opening 50 from a first surface 54 of the substrate 52 to beyond a second surface 56 of the substrate 52. As the mating connector receiving portion 18 and the mating connector receiving surface 20 extends beyond the second surface 56, the mating connector receiving portion 18 is positioned to receive a mating connector 58 which terminates a cable 60 therein.

As shown in FIGS. 2, 3, 5, 9 and 11, the substrate mounting portion 22 is positioned proximate the first surface 54 of the substrate 52. As the substrate mounting surface 24 and the substrate mounting portion 22 are dimensioned to be larger than the opening 50 in the substrate 52, the substrate mounting surface 24 and the substrate mounting portion 22 are prevented from moving beyond the first surface 54.

When the connector 10 is properly inserted into the opening 50 of the substrate 52, the surface mount portion 37 of the contact 16 is provided in mechanical and electrical engagement with a signal contact pad 62 provided on the first surface 54 of the substate 52. The surface mount portion 37 is retained in mechanical and electrical engagement with the signal contact pad 62 by solder or other known methods. The signal contact pad 62 is provided in electrical engagement with one or more traces 64 of the substrate. The one or more traces 64 are in electrical engagement with a chip or other device, as represented by 66 in FIG. 11, located on the first surface 54.

In addition, the PCB ground or legs 26 is provided in mechanical and electrical engagement with one or more grounding pads 68 provided on the first surface 54 of the substate 52. The PCB ground or legs 26 are retained in mechanical and electrical engagement with the grounding contact pad 68 by solder or other known methods.

By having a connector 10 which extends through an opening 50 in a substrate 52, a main board or other component or device 70 can be electrically connected to a component or device 66 on a first side 54 of a substrate 52 which is accessible through the RF connector 10, as represented by area 72 in FIG. 11. This is beneficial when the distance D does not allow the device 66 to be positioned on the second side 56 of the substrate 52 because of space limitations. The use of the connector 10 also allows more devices to be positioned on the first side 54, thereby allowing for a higher density of the devices in a limited or confined space.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An RF connector comprising:
a conductive shell;
a dielectric insert;
a contact;
the conductive shell having a mating connector receiving portion and a substrate mounting portion, the substrate mounting portion having a substrate mounting surface, the mating connector receiving portion extending from the substrate mounting surface;
the contact having a surface mount portion positioned proximate the substrate mounting surface of the substrate mounting portion.

2. The RF connector as recited in claim 1, wherein the conductive shell is formed in at least one piece and is made of metal.

3. The RF connector as recited in claim 1, wherein the mating connector receiving portion has a mating connector receiving surface, the mating connector receiving surface extends in a plane which is essentially parallel to a plane in which the substrate mounting surface extends.

4. The RF connector as recited in claim 1, wherein PCB ground extend from the substrate mounting portion proximate the substrate mounting surface.

5. The RF connector as recited in claim 4, wherein the PCB ground or legs are integrally formed with the conductive shell.

6. The RF connector as recited in claim 1, wherein a dielectric receiving passage is provided in the substrate mounting portion, the dielectric receiving passage opens to the mating connector receiving portion.

7. The RF connector as recited in claim 6, wherein the dielectric insert is configured to be positioned in the dielectric receiving passage which extends from a first surface proximate the mating connector receiving portion to a second surface in the substrate mounting portion, the first surface extends in a plane which is essentially perpendicular to a plane in which the second surface extends.

8. The RF connector as recited in claim 1, wherein the contact has a first straight portion which extends into the mating connector receiving portion, a second straight portion which extends into the substrate mounting portion, and a arcuate portion which is extends between the first straight portion and the second straight portion, the surface mount portion positioned on the second straight portion.

9. The RF connector as recited in claim 8, wherein the dielectric insert is made of three components.

10. The RF connector as recited in claim 9, wherein a first component extends around the first straight portion of the contact, a second component is positioned to the side of the contact and to the side of the first component, and a third component is positioned proximate the first component and the second component, the third component extends 360 degrees around the second straight portion of the contact.

11. An electrical assembly comprising:
a substrate with an opening extending from a first surface of the substrate to a second surface of the substrate;
an RF connector comprising:
a conductive shell;
a dielectric insert;
a contact;
the conductive shell having a mating connector receiving portion and a substrate mounting portion, the substrate mounting portion having a substrate mounting surface which engages the first surface of the substrate, the mating connector receiving portion extending from the substrate mounting surface through the opening to the second surface of the substrate;
the contact having a surface mount portion positioned proximate the substrate mounting surface of the substrate mounting portion, the surface mount portion being mechanically and electrically engaged with a contact pad on the first surface of the substrate;
wherein an electrical connection can be made between a device on the second side of the substrate and a component mounted on the first side through the RF connector.

12. The electrical assembly as recited in claim 11, wherein the conductive shell of the RF connector is formed in at least one piece and is made of metal.

13. The electrical assembly as recited in claim 11, wherein the mating connector receiving portion has a mating connector receiving surface, the mating connector receiving surface extends in a plane which is essentially parallel to a plane in which the substrate mounting surface extends.

14. The electrical assembly as recited in claim 11, wherein PCB ground extend from the substrate mounting portion proximate the substrate mounting surface, the PCB ground are mechanically and electrically engaged with one or more grounding pads on the first surface of the substrate.

15. The electrical assembly as recited in claim 14, wherein the PCB ground or legs are integrally formed with the conductive shell.

16. The electrical assembly as recited in claim 11, wherein a dielectric receiving passage is provided in the substrate mounting portion, the dielectric receiving passage opens to the mating connector receiving portion.

17. The electrical assembly as recited in claim 16, wherein the dielectric insert is configured to be positioned in the dielectric receiving passage which extends from a first surface of the dielectric insert proximate the mating connector receiving portion to a second surface of the dielectric insert in the substrate mounting portion, the first surface of the dielectric insert extends in a plane which is essentially perpendicular to a plane in which the second surface of the dielectric insert extends.

18. The electrical assembly as recited in claim 11, wherein the contact has a first straight portion which extends into the mating connector receiving portion, a second straight portion which extends into the substrate mounting portion, and a arcuate portion which is extends between the first straight portion and the second straight portion, the surface mount portion positioned on the second straight portion.

19. The electrical assembly as recited in claim 18, wherein the dielectric insert is made of three components.

20. The electrical assembly as recited in claim 19, wherein a first component extends around the first straight portion of the contact, a second component is positioned to the side of the contact and to the side of the first component, and a third component is positioned proximate the first component and the second component, the third component extends 360 degrees around the second straight portion of the contact.
